(19) United States
(12) Patent Application Publication
(10) Pub. No.: US 2024/0113546 A1
(43) Pub. Date: Apr. 4, 2024

(54) Power Supply System

(71) Applicant: TOYOTA JIDOSHA KABUSHIKI KAISHA, Toyota-shi Aichi-ken State/Province (JP)

(72) Inventor: Hirotsugu OHATA, Susono-shi Shizuoka-ken (JP)

(73) Assignee: TOYOTA JIDOSHA KABUSHIKI KAISHA, Toyota-shi Aichi-ken (JP)

(21) Appl. No.: 18/369,872

(22) Filed: Sep. 19, 2023

(30) Foreign Application Priority Data
Sep. 30, 2022 (JP) 2022-158488

(51) Int. Cl. H02J 7/00

(52) U.S. Cl. CPC H02J 7/007182; H02J 7/0019; H02J 7/0063; H02J 2207/20

(57) ABSTRACT

A power supply system is composed of a plurality of cell units connected in parallel. Each of the cell units includes a battery pack and a converter. A control device subjects the cell unit to voltage control such that an output voltage from the power supply system attains to a voltage command and subjects a cell unit different from the cell unit subjected to voltage control to power control such that output power from the power supply system attains to a power command, and switches a cell unit to be subjected to voltage control every prescribed period.

### CROSS REFERENCE TO RELATED APPLICATIONS

This nonprovisional application is based on Japanese Patent Application No. 2022-158488 filed with the Japan Patent Office on Sep. 30, 2022, the entire contents of which are hereby incorporated by reference.

### BACKGROUND

### Field

The present disclosure relates to a power supply system and particularly to a power supply system in which a plurality of cell units each including a cell and a converter are connected in parallel.

### Description of the Background Art

Japanese Patent Laying-Open No. 2014-103804 discloses a technique to equalize voltages of a plurality of battery assemblies in a cell system in which the plurality of battery assemblies are connected in parallel.

### SUMMARY

In a cell system (power supply system) in which a plurality of battery assemblies (cells) are connected in parallel, voltages of the cells are different due to a difference in characteristic of the cells or deterioration of the cells, and a circulating circuit is generated. A converter may be provided for each set of cells connected in parallel to suppress the circulating circuit to thereby suppress deterioration of the cells caused by the circulating circuit.

In a power supply system where cell units each including a cell and a converter are connected in parallel, an output voltage and output power of the power supply system are desirably controlled to desired values. For example, the converter in each cell unit is controlled based on a voltage command and a power command required by a load or the like connected to the power supply system. In this case, voltage control may be carried out in a prescribed cell unit such that the output voltage from the power supply system attains to a voltage command and power control may be carried out in another cell unit such that output power from the power supply system attains to a power command.

When a difference between output power and a power command in power control is produced (power deviation occurs) due to an error of various sensors or response delay or the like in control, the output voltage varies. Since voltage control is carried out in response to variation in output voltage due to power deviation, an amount of operations by the cell unit subjected to voltage control may increase, loads (power burdens) imposed on a prescribed cell unit (cell unit subjected to voltage control) may increase, and deterioration of the prescribed cell unit may be accelerated.

An object of the present disclosure is to equalize loads (burdens) imposed on cell units in a power supply system in which cell units each including a cell and a converter are connected in parallel.

In a first aspect, a power supply system in the present disclosure includes a plurality of cell units connected in parallel, each of the plurality of cell units including a cell and a converter, and a control device that controls each of the plurality of cell units. The control device subjects at least one cell unit of the plurality of cell units to voltage control such that an output voltage from the power supply system attains to a voltage command and subjects remaining cell unit(s) to power control such that output power from the power supply system attains to a power command. The control device is configured to switch the at least one cell unit to be subjected to voltage control every prescribed period.

According to this configuration, the cell unit to be subjected to voltage control is switched every prescribed period. Since cell units to be subjected to voltage control are successively switched even when power deviation occurs, loads (power burdens) imposed on the cell units can be equalized.

In a second aspect according to the first aspect, a single cell unit may be provided as the at least one cell unit.

According to this configuration, since a cell unit other than the single cell unit subjected to voltage control is subjected to power control, responsiveness in power control can be enhanced and the difference between output power and the power command can be made smaller. Power variation in the load connected to the power supply system can thus be responded to while variation in output voltage is suppressed.

In a third aspect according to the first aspect, a three-phase inverter may be diverted for use as the converter, and cells different from one another may be connected to arms of respective phases of the three-phase inverter.

An electrically powered vehicle such as a hybrid electric vehicle (HEV) or a battery electric vehicle (BEV) has more widely been used in recent years. Recycle or reuse of a battery (cell) or a power control unit (PCU) collected on the occasion of replacement purchase or disassembly of these vehicles is desired. According to this configuration, a three-phase inverter of the collected PCU can be diverted for use as a converter of the power supply system (cell unit), so that reuse of the PCU is promoted. When a collected battery (cell) is also used as the cell of the power supply system (cell unit), reuse of the battery can also be promoted.

In a fourth aspect according to the third aspect, the power supply system may further include a plurality of power supply sub units connected in parallel to each other, each of the plurality of power supply sub units including three cell units, the three cell units may include the cells connected to the arms of different phases of the three-phase inverter, respectively, and the control device may be configured to carry out the voltage control and the power control in units of a power supply sub unit of the plurality of power supply sub units.

According to this configuration, the power supply sub unit is constituted of the three-phase inverter and (three) cells connected to the three-phase inverter. The power supply sub unit is constituted of three cell units. The power supply system is constituted of the power supply sub units connected in parallel. Since voltage control and power control are carried out in units of the power supply sub unit, the three cell units included in the power supply sub unit are controlled under identical control (voltage control or power control).

Voltage control and power control are carried out in units of the power supply sub unit, so that hardware of an electronic control unit (ECU) that carries out drive control of the PCU (three-phase inverter) can relatively easily be made use of as a control device. Utilization and use of the ECU that carries out drive control of the PCU (three-phase inverter) of the electrically powered vehicle as the control device can thus be promoted.

In a fifth aspect according to the fourth aspect, a single power supply sub unit of the plurality of power supply sub units may be subjected to the voltage control.

According to this configuration, since a power supply sub unit other than the single power supply sub unit subjected to voltage control is subjected to power control, responsiveness in power control can be enhanced and the difference between output power and the power command can be made smaller. Power variation in the load connected to the power supply system can thus be responded to while variation in output voltage is suppressed.

In a sixth aspect according to the first to the fifth aspect, the control device may set the prescribed period in accordance with a state of the at least one cell unit subjected to the voltage control.

According to this configuration, since the prescribed period is set in accordance with the state of the cell unit subjected to voltage control, for example, a period for voltage control of a cell unit, deterioration of which tends to be accelerated by voltage control, can be shorter and deterioration of that cell unit can be suppressed.

In a seventh aspect according to a sixth aspect, the state of the cell unit subjected to voltage control may be represented by a degree of deterioration of the cell included in the at least one cell unit, and the control device may set the prescribed period to be shorter as the degree of deterioration of the cell is higher.

According to this configuration, as the degree of deterioration of the cell is higher, the period for voltage control of the cell unit including that cell can be shorter and further deterioration of that cell unit can be suppressed.

The foregoing and other objects, features, aspects and advantages of the present disclosure will become more apparent from the following detailed description of the exemplary embodiments when taken in conjunction with the accompanying drawings.

### BRIEF DESCRIPTION OF THE DRAWINGS

FIG. 1 is a diagram showing an overall configuration of a power supply system in the present embodiment.

FIG. 2 is a diagram illustrating an exemplary electrically powered vehicle.

FIG. 3 is a diagram showing an exemplary configuration of a control device of the power supply system.

FIG. 4 is an exemplary block diagram for control of output power from the power supply system in the present embodiment.

FIG. 5 is a flowchart showing exemplary voltage control switching processing performed by the control device.

FIG. 6 is a diagram illustrating a control device of a power supply system according to a first modification.

FIG. 7 is a flowchart showing exemplary voltage control switching processing performed by the control device in the first modification.

FIG. 8 is a diagram showing an overall configuration of a power supply system in a second modification.

### DESCRIPTION OF THE EMBODIMENTS

An embodiment of the present disclosure will be described in detail below with reference to the drawings. The same or corresponding elements in the drawings have the same reference characters allotted and description thereof will not be repeated.

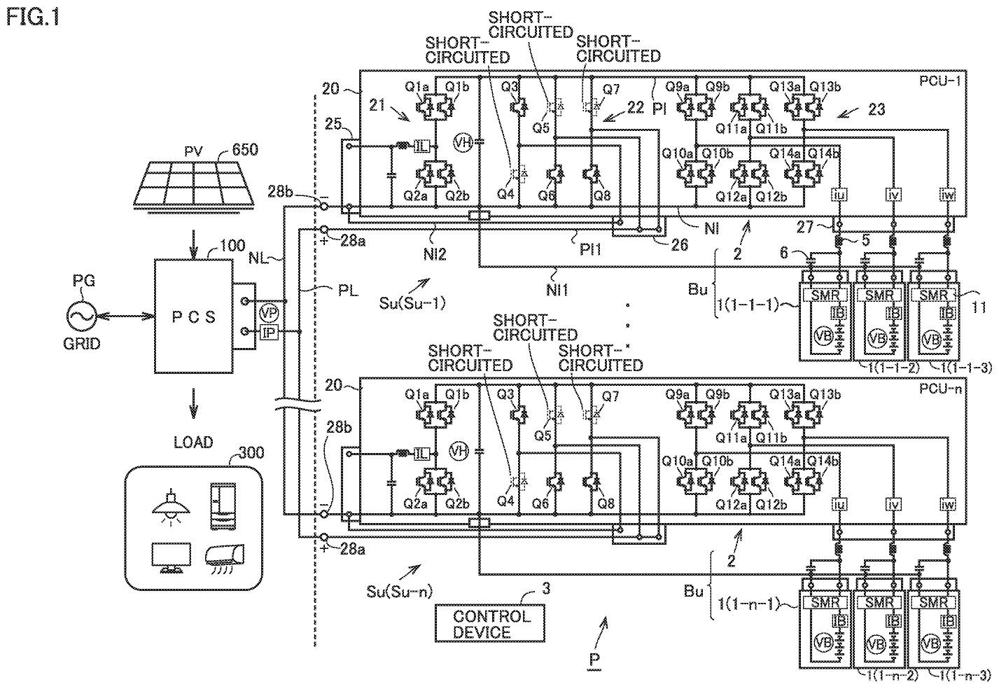

FIG. 1 is a diagram showing an overall configuration of a power supply system P in the present embodiment. Power supply system P includes a power supply sub unit Su and a control device 3, power supply sub unit Su including three battery packs 1 and a converter 2. In the present embodiment, a battery pack and a PCU mounted on an electrically powered vehicle are diverted for use as power supply sub unit Su in power supply system P. An exemplary configuration of an electrically powered vehicle on which a battery pack and a PCU are mounted will be described.

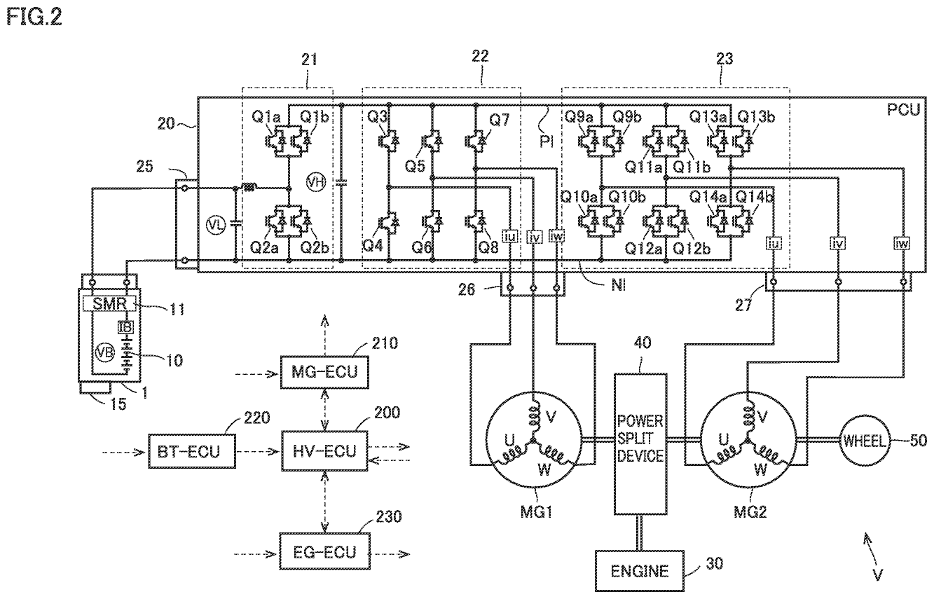

FIG. 2 is a diagram illustrating an exemplary electrically powered vehicle. In FIG. 2, an electrically powered vehicle V is a hybrid electric vehicle in which a rotating electric machine and an engine are both used for drive of the vehicle. Electrically powered vehicle V includes battery pack 1, a PCU 20, an engine 30, motor generators MG1 and MG2 as rotating electric machines, a power split device 40, and a drive wheel 50.

Battery pack 1 includes a battery 10 and a system main relay (SMR) 11. Battery 10 is a battery assembly in which cells each implemented by a secondary battery such as a nickel metal hydride battery or a lithium ion battery are electrically connected in series. Battery pack 1 has an output terminal (a positive terminal and a negative terminal) connected to a battery connection terminal 25 of PCU 20. As SMR 11 is closed, battery 10 and PCU 20 are connected to each other. As SMR 11 is opened, battery 10 and PCU 20 are disconnected from each other. Battery pack 1 is provided with a monitoring unit 15 that detects a voltage VB of battery 10, an input and output current IB to and from battery 10, a temperature TB of battery 10, and the like.

PCU 20 includes a boost converter 21, an inverter 22, and an inverter 23. Boost converter 21 boosts battery voltage VB inputted from battery pack 1 and outputs the boosted battery voltage to inverter 22 and inverter 23. Inverter 22 converts direct-current (DC) power boosted by boost converter 21 into three-phase alternating-current (AC) power and drives motor generator MG1, for example, to start engine 30. Inverter 22 converts AC power generated by motor generator MG1 with motive power transmitted from engine 30 into DC power and sends resultant DC power back to boost converter 21. At this time, boost converter 21 is controlled to operate as a down-conversion circuit. Inverter 23 converts DC power outputted from boost converter 21 into three-phase AC power and outputs resultant AC power to motor generator MG2.

Power split device 40 is a mechanism coupled to engine 30 and motor generators MG1 and MG2 to distribute motive power thereamong. A planetary gear mechanism can be employed as power split device 40, and for example, engine 30 is connected to a planetary carrier, motor generator MG1 is connected to a sun gear, and motor generator MG2 is connected to a ring gear. A rotor of motor generator MG2 (and a rotation shaft of the ring gear of power split device 40) is coupled to drive wheel 50 with a reduction gear, a differential gear, and a driveshaft that are not shown being interposed.

Boost converter 21 of PCU 20 includes a reactor and switching elements Q1a, Q1b, Q2a, and Q2b. Switching elements Q1a to Q2b are each implemented, for example, by an insulated gate bipolar transistor (IGBT) element, and each of them includes a diode connected in anti-parallel to the IGBT element. Switching element Q1a and switching element Q1b are provided in parallel. Switching element Q2a and switching element Q2b are provided in parallel. Switching element Q1a and switching element Q1b are driven by an identical drive signal. Switching element Q2a and switching element Q2b are driven by an identical drive signal. Switching elements Q1a and Q1b have their collectors connected to a positive electrode line P1. Switching elements Q2a and Q2b have their emitters connected to a negative electrode line N1. The reactor is connected to emitters of switching elements Q1a and Q1b and collectors of switching elements Q2a and Q2b.

Inverter 22 is a three-phase inverter, and includes a U-phase arm composed of switching elements Q3 and Q4 connected in series between positive electrode line P1 and negative electrode line N1, a V-phase arm composed of switching elements Q5 and Q6 connected in series between positive electrode line P1 and negative electrode line N1, and a W-phase arm composed of switching elements Q7 and Q8 connected in series between positive electrode line P1 and negative electrode line N1. Switching elements Q3 to Q8 are switching elements each including a diode connected in anti-parallel to an IGBT element, similarly to switching element Q1a.

Intermediate points of the arms of respective phases are connected to coils of respective phases of motor generator MG1 with an MG1 connection terminal 26 being interposed. Motor generator MG1 is a three-phase permanent magnet synchronous motor, and it may be, for example, an interior permanent magnet (IPM) synchronous electric motor.

Inverter 23 is a three-phase inverter similar in configuration to inverter 22 except for switching elements in the arms of respective phases are provided in parallel. Switching elements Q9a and Q9b correspond to switching element Q3 and switching elements Q10a and Q10b correspond to switching element Q4, and the U-phase arm is constituted of them. Switching elements Q11a and Q11b correspond to switching element Q5 and switching elements Q12a and Q12b correspond to switching element Q6, and the V-phase arm is constituted of them. Switching elements Q13a and Q13b correspond to switching element Q7 and switching elements Q14a and Q14b correspond to switching element Q8, and the W-phase arm is constituted of them.

Intermediate points of the arms of respective phases are connected to coils of respective phases of motor generator MG2 with an MG2 connection terminal 27 being interposed. Motor generator MG2 may also be an IPM synchronous electric motor.

PCU 20 is provided with a current sensor iu that detects a U-phase current iu in each of inverter 22 and inverter 23, a current sensor iv that detects a V-phase current iv in each of inverter 22 and inverter 23, and a current sensor iw that detects a W-phase current iw in each of inverter 22 and inverter 23. PCU 20 includes a voltage sensor VH that detects a system voltage VH which is a voltage supplied from boost converter 21 to inverters 22 and 23 and a voltage sensor VL that detects a voltage VL inputted from battery pack 1 to boost converter 21.

Electrically powered vehicle V includes a hybrid electronic controller (HV-ECU) 200, a motor generator ECU (MG-ECU) 210, a battery ECU (BT-ECU) 220, and an engine ECU (EG-ECU) 230 as control devices. Each ECU includes a central processing unit (CPU), a memory, and a buffer (none of which is shown).

Monitoring unit 15 includes a voltage sensor VB that detects voltage VB of battery 10, a current sensor IB that detects input and output current IB, or the like. BT-ECU 220 calculates a state of charge (SOC) of battery 10 based on voltage VB, input and output current IB, or the like detected by monitoring unit 15 and transmits the SOC to HV-ECU 200. BT-ECU 220 calculates states of health (SOH) representing a state of battery 10 based on a history or the like of voltage VB, input and output current IB, and temperature TB and transmits the SOH to HV-ECU 200. The SOH may be represented, for example, by a capacity retention or a rate of increase in internal resistance of battery 10 and it is a parameter representing a degree of deterioration of battery 10.

HV-ECU 200 calculates requested drive torque Tr, for example, based on an accelerator position, a vehicle speed, or the like for travel control of electrically powered vehicle V and calculates requested power Pd by multiplying requested drive torque Tr by a rotation speed of drive wheel 50. HV-ECU 200 sets requested power Pe requested of engine 30 by subtracting charging and discharging power Pb (a positive value in discharging from battery 10) based on the SOC of battery 10 from requested power Pd. HV-ECU 200 then sets a target engine rotation speed Ne, target engine torque Te, command torque Tm1 for motor generator MG1, and command torque Tm2 for motor generator MG2 such that requested power Pe is outputted from engine 30 and requested drive torque Tr is outputted to drive wheel 50.

MG-ECU 210 subjects each switching element of inverter 22 to pulse width modulation (PWM) control such that command torque Tm1 is outputted from motor generator MG1. MG-ECU 210 subjects each switching element of inverter 23 to PWM control such that command torque Tm2 is outputted from motor generator MG2.

EG-ECU 230 controls engine 30 to operate at target engine rotation speed Ne and target engine torque Te.

Referring to FIG. 1, in power supply system P, battery pack 1 and PCU 20 mounted on electrically powered vehicle V are diverted for use as battery pack 1 and converter 2. Positive terminals of output terminals of three battery packs 1 (1-1-1, 1-1-2, and 1-1-3) are connected to MG2 connection terminal 27 to which the intermediate points of the arms of respective phases (the U-phase arm, the V-phase arm, and the W-phase arm) of inverter 23 (three-phase inverter) of PCU 20 are connected, with a coil (inductor) 5 being interposed. A power line between the positive terminal of battery pack 1 and coil 5 is connected to the negative terminal of the output terminal of battery pack 1 with a capacitor 6 being interposed. Battery pack 1 has the negative terminal connected to negative electrode line N1 of PCU 20 through a power line N11. FIG. 1 does not show monitoring unit 15.

In FIG. 1, switching element Q4, switching element Q5, and switching element Q7 of inverter 22 of PCU 20 are short-circuited. At MG1 connection terminal 26 to which the intermediate points of the arms of respective phases of inverter 22 are connected, a terminal to which the U-phase arm is connected is connected to the negative terminal of battery connection terminal 25 through a power line N12. Battery connection terminal 25 has the negative terminal connected to a negative terminal 28b of a power supply sub unit Su. At MG1 connection terminal 26, terminals to which the V-phase arm and the W-phase arm are connected are connected to a positive terminal 28a of power supply sub unit Su through a power line P11.

As the arms of respective phases of inverter 23 of PCU 20 are thus connected to battery pack 1, at least one of the switching elements of inverter 22 is short-circuited, and MG1 connection terminal 26 is connected to positive terminal 28a and negative terminal 28b of power supply sub unit Su, PCU 20 is diverted for use as converter 2 that boosts the voltage of battery pack 1 (battery 10) connected to the arms of the phases of inverter 23.

In FIG. 1, battery pack 1 corresponds to an exemplary “cell” in the present disclosure. A chopper circuit composed of the arms of the respective phases corresponding to one battery pack 1 (connected to one battery pack 1), coil 5, and capacitor 6 corresponds to the “converter” in the present disclosure. In FIG. 1, for the sake of convenience, the three converters collectively have a reference numeral 2 allotted. A feature including battery pack 1 and single converter 2 corresponds to the “cell unit” in the present disclosure. For example, in FIG. 1, battery pack 1-1-1, the U-phase arm (switching elements Q9b, Q9b, Q10a, and Q10b), coil 5 connected to the intermediate point of the U-phase arm, and capacitor 6 provided in the power line between the positive terminal of battery pack 1-1-1 and coil 5 correspond to the “cell unit” in the present disclosure. In the description of the present embodiment, a cell unit has a reference numeral Bu allotted without the cell units being distinguished from each other.

Power supply sub unit Su is composed of three cell units Bu each including converter 2 diverted from PCU 20. In power supply sub unit Su, power supply units Bu are connected in parallel. Power supply system P includes a plurality of power supply sub units Su, and power supply sub units Su are connected in parallel with respect to a PCS 100. In the present embodiment, power supply system P includes n (n being a positive integer) power supply sub units Su and may include, for example, twenty power supply sub units Su. In power supply sub unit Su, three cell units Bu (battery packs 1) are connected in parallel. In power supply system P including twenty power supply sub units Su, sixty cell units Bu (battery packs 1) are connected in parallel. In FIG. 1, n in a reference numeral Su-n indicates an nth power supply sub unit Su. n in the reference numerals 1-n-1, 1-n-2, and 1-n-3 indicates battery pack 1 included in nth power supply sub unit Su.

Positive terminal 28a of each power supply sub unit Su is connected to an input and output terminal of PCS 100 through a positive electrode line PL. Negative terminal 28b of each power supply sub unit Su is connected to the input and output terminal of PCS 100 through a negative electrode line NL.

PCS 100 is connected not only to power supply system P but also to a power grid PG, a photovoltaic power generator 650, and a load (electrical load) 300. Power grid PG is, for example, a commercial power supply composed of a power plant and a power transmission network. PCS 100 includes a power conversion device, and supplies electric power generated by photovoltaic power generator 650 to load 300 or performs back feeding. When there is a posiwatt DR request, PCS 100 converts AC power of power grid PG into DC power and charges power supply system P (cell unit Bu). When there is a negawatt DR request, PCS 100 converts discharging power (output power) from power supply system P (cell unit Bu) into AC power and supplies electric power to load 300 or performs back feeding. Load 300 may be a household load (home appliance) or an electrical load in a business entity or a factory.

Power supply system P performs an interconnected operation in which electric power is supplied and received to and from power grid PG and an isolated operation in which power supply system P is isolated (cut off) from power grid PG. In the interconnected operation, electric power from power grid PG is mainly supplied to load 300. In the interconnected operation, power supply system P supplies and receives electric power to and from power grid PG in response to a request for negawatt DR or posiwatt DR. During the isolated operation of power supply system P, output power (discharging power) from power supply system P (cell unit Bu) is supplied to load 300.

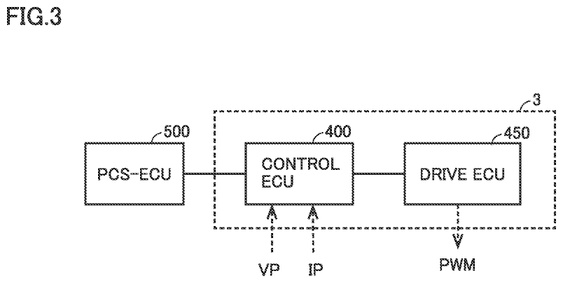

FIG. 3 is a diagram showing an exemplary configuration of control device 3 of power supply system P. Control device 3 includes a control ECU 400 and a drive ECU 450. Each ECU includes a CPU, a memory, and a buffer (none of which is shown). A PCS-ECU 500 is a control device that controls PCS 100 and outputs to control ECU 400, a power command RP which is a requested value of electric power to be outputted from power supply system P (cell unit Bu) or a requested value of electric power to be inputted to power supply system P and a voltage command RV which is a command value of a voltage to be outputted from power supply system P.

Control ECU 400 generates an output power command TP based on power command RP and voltage command RV in output of electric power from power supply system P (in discharging from cell unit Bu). Drive ECU 450 subjects the cell unit (converter 2) to PWM control such that output power from power supply system P attains to output power command TP.

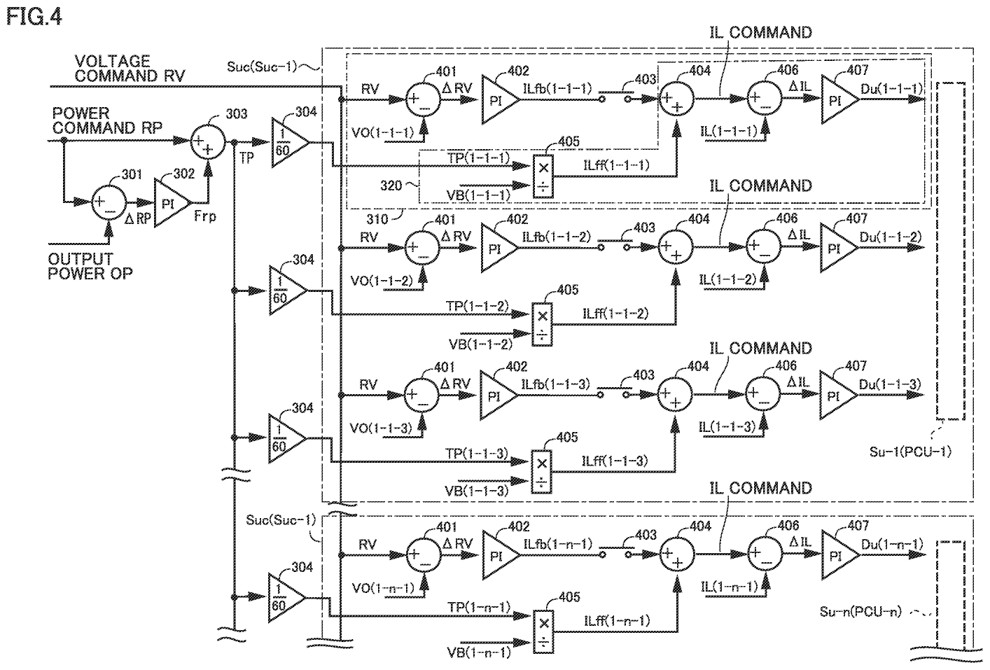

FIG. 4 is an exemplary block diagram for control of output power from power supply system P in the present embodiment. This block diagram may be configured by software and/or hardware in control ECU 400 and drive ECU 450. In FIG. 4, voltage command RV and power command RP are inputted from PCS-ECU 500. Voltage command RV may indicate a requested value (target voltage) of the output voltage from power supply system P, and it may be set, for example, to 100 V, 200 V, or 600 V. Power command RP may indicate electric power requested by a load or the like (to be supplied to the load or the like) connected to PCS 100.

For example, when voltage control is carried out in prescribed cell unit Bu such that an output voltage VP from power supply system P attains to voltage command RV and power control is carried out in another cell unit Bu such that output power OP from power supply system P attains to power command RP, a difference between output power OP and power command RP is produced (power deviation occurs) due to an error of the current sensor or response delay in power control and output voltage VP varies. Since voltage control is carried out in response to this variation in output voltage VP, an amount of operations by prescribed cell unit Bu subjected to voltage control increases, loads (burdens) imposed on that cell unit Bu increases, and deterioration of (battery pack 1 included in) that cell unit Bu may be accelerated. Therefore, in the first embodiment, in order to equalize the loads (burdens) imposed on cell units Bu (battery packs 1), cell unit Bu subjected to voltage control is switched every prescribed period.

In FIG. 4, power command RP and output power OP inputted from PCS-ECU 500 are inputted to a subtraction point 301. Output power OP is output power from power supply system P and may be calculated from output voltage VP and an output current IP from the power supply system. A difference ΔRP between power command RP and output power OP is outputted from subtraction point 301 and inputted to a PI controller 302. PI controller 302 serves for feedback control by proportional integral control (PI control) and outputs a power correction Frp such that difference ΔRP is 0 (output power OP is equal to power command RP).

Power command RP and power correction Frp are inputted to an addition point 303, and addition point 303 outputs an output power command TP for power supply system P. Output power command TP outputted from addition point 303 is inputted to a distributor 304. Distributor 304 outputs a unit power command TP (N) which is a command value for output power (unit output power) from each cell unit Bu. In power supply system P in the present embodiment, sixty cell units Bu are connected in parallel. Distributor 304 distributes 1/60 of output power command TP to each cell unit Bu. For example, distributor 304 multiplies output power command TP by “ 1/60” and outputs unit power command TP (N). “N” in unit power command TP (N) corresponds to the reference numeral of the battery pack included in cell unit Bu. For example, unit power command TP (N) for cell unit Bu including battery pack 1-n-1 is denoted as a unit power command TP (1-n-1). “N” is handled similarly hereafter, and “N” is assumed to correspond to the reference numeral of the battery pack.

Since cell units Bu are common except for calculation of unit power command TP (N), cell unit Bu including battery pack 1-1-1 will be described below.

Voltage command RV inputted from PCS-ECU 500 and a unit output voltage VO (1-1-1) which is an output voltage from cell unit Bu are inputted to a subtraction point 401. A difference ΔRV between voltage command RV and unit output voltage VO (1-1-1) is outputted from subtraction point 401 to a PI controller 402. Unit output voltage VO (1-1-1) may be a detection value detected by voltage sensor VH that detects system voltage VH, voltage sensor VH having been provided in PCU 20 diverted for use in a power supply sub unit Su-1.

PI controller 402 serves for feedback control under proportional integral control (PI control), and outputs a voltage feedback amount (a voltage FB amount) ILfb (1-1-1) such that difference ΔRV is 0 (unit output voltage VO (1-1-1) is equal to voltage command RV). Voltage FB amount ILfb (1-1-1) serves for control of an output current from cell unit Bu such that difference ΔRV is 0. Voltage FB amount ILfb (1-1-1) is inputted to an addition point 404 through a switch 403.

As switch 403 is closed, voltage FB amount ILfb (1-1-1) is inputted to addition point 404. When switch 403 is open, voltage FB amount ILfb (1-1-1) is not inputted to addition point 404. In this case (when switch 403 is open), voltage FB amount ILfb (1-1-1) is handled as 0 at addition point 404.

Unit power command TP (1-1-1) outputted from distributor 304 and a voltage VB (1-1-1) of battery 10 included in battery pack 1-1-1 are inputted to a multiplier (divider) 405. Voltage VB (1-1-1) may be a detection value detected by voltage sensor VB that detects voltage VB of battery 10 in battery pack 1-1-1. Multiplier (divider) 405 calculates a current feedforward amount (current FF amount) ILff (1-1-1) by dividing unit power command TP (1-1-1) by voltage VB (1-1-1). Calculated current FF amount ILff (1-1-1) is inputted to addition point 404. Current FF amount ILff (1-1-1) serves for control of an output current from cell unit Bu such that output power OP attains to power command RP.

At addition point 404, voltage FB amount ILfb (1-1-1) is added to current FF amount ILff (1-1-1) and an IL command is outputted. The IL command outputted from addition point 404 and IL (1-1-1) which represents an output current from cell unit Bu are inputted to a subtraction point 406. A difference AIL between the IL command and IL (1-1-1) is outputted from subtraction point 406 to a PI controller 407. IL (1-1-1) represents an output current from cell unit Bu including battery pack 1-1-1 and it may represent a detection value detected by current sensor iu that detects U-phase current iu of the U phase to which battery pack 1-1-1 is connected or a detection value detected by current sensor IB that detects input and output current IB to and from battery 10 in battery pack 1-1-1.

PI controller 407 serves for feedback control under proportional integral control (PI control) and outputs a duty ratio Du (1-1-1) resulting from addition of a proportional term and an integral term such that difference AIL is 0 (IL (1-1-1) is equal to the IL command). Converter 2 (the U-phase arm (switching elements Q9a, Q9b, Q10a, and Q10b)) of cell unit Bu including battery pack 1-1-1 is subjected to PWM control at duty ratio Du (1-1-1). All cell units Bu are similarly controlled.

Since voltage FB amount ILfb (1-1-1) is added to the IL command while switch 403 is closed, duty ratio Du (1-1-1) controls cell unit Bu such that unit output voltage VO (1-1-1) attains to voltage command RV. Such voltage control that output voltage VP from power supply system P attains to voltage command RV is thus carried out. While switch 403 is closed, subtraction point 401 to PI controller 407 perform a function as a voltage control unit 310.

Since the IL command is equal to current FF amount ILff (1-1-1) while switch 403 is open, duty ratio Du (1-1-1) controls cell unit Bu such that output power from cell unit Bu attains to unit power command TP (1-1-1). Such power control that output power OP from power supply system P attains to power command RP is thus carried out. While switch 403 is open, addition point 404 to PI controller 407 perform a function as a power control unit 320.

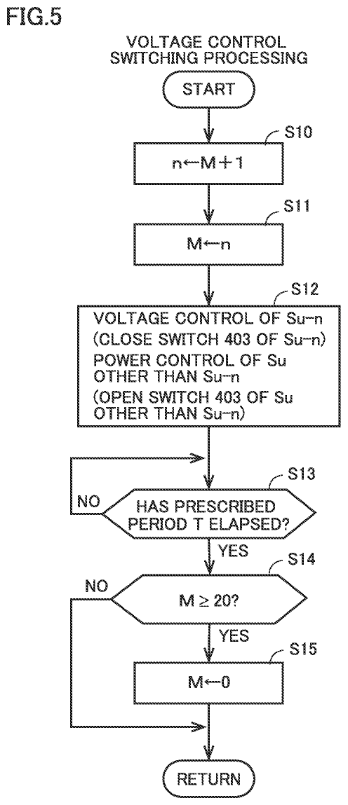

FIG. 5 is a flowchart showing exemplary voltage control switching processing performed by control device 3. This flowchart is executed during discharging of power supply system P (cell unit Bu), and it is executed, for example, when power command RP inputted from PCS-ECU 500 indicates discharging power.

In step (the step being abbreviated as “S” below) 10, n is set to “M+1”. An initial value of M is set to 0, and hence n is set to 1 when S10 is first performed.

In subsequent S11, M is set to n. When S11 is first performed, M is set to 1 because n has been set to 1.

In S12, three cell units Bu included in a power supply sub unit Su-n are subjected to voltage control and cell units Bu included in power supply sub unit Su other than power supply sub unit Su-n are subjected to power control. When S12 is first performed, n has been set to 1. Therefore, three cell units Bu included in a power supply sub unit Su-1 are subjected to voltage control and cell units Bu included in power supply sub unit Su other than power supply sub unit Su-1 are subjected to power control.

By closing switch 403 connected to three cell units Bu included in power supply sub unit Su-n, control device 3 subjects the power supply sub unit to voltage control. By opening switch 403 connected to cell unit Bu included in power supply sub unit Su other than power supply sub unit Su-n, control device 3 subjects power supply sub unit Su other than power supply sub unit Su-n to power control.

In subsequent S13, whether or not a prescribed period T has elapsed since start of voltage control of power supply sub unit Su-n is determined. Prescribed period T may be set to any period. For example, in an example where discharging from power supply system P is based on a request for negawatt DR in units of thirty-minute frames and negawatt DR for two frames (sixty minutes) is requested, prescribed period T may be set to three minutes. In the present embodiment, twenty power supply sub units Su are provided. By switching of power supply sub units Su (cell units Bu) to be subjected to voltage control every three minutes, all power supply sub units Su (cell units Bu) can be subjected to voltage control within a discharging period.

When prescribed period T has elapsed since start of voltage control of power supply sub unit Su-n, determination as YES is made in S13 and the process proceeds to S14. In S14, whether or not M is equal to or larger than twenty is determined. “Twenty” is the number of power supply sub units Sn connected in parallel in power supply system P. When M is smaller than twenty, determination as NO is made and the process is resumed from S10. When M is equal to or larger than twenty, determination as YES is made. In S15, M is set to 0, and thereafter the process is resumed from S10.

When discharging from power supply system P is stopped in the middle of the present voltage control switching processing, M at that time is held and the voltage control switching processing ends. When discharging from power supply system P is resumed, the process is resumed from the processing in S10 by using M that has been held.

According to this embodiment, power supply sub unit Sn (cell unit Bu) to be subjected to voltage control is switched every prescribed period T. Since cell unit Bu to be subjected to voltage control is successively switched even when power deviation occurs, loads (power burdens) imposed on cell units Bu can be equalized. Since power supply sub unit Su other than single power supply sub unit Su subjected to voltage control is subjected to power control, responsiveness in power control can be enhanced and a difference between output power OP and power command RP can be made smaller. Power variation in the load connected to the power supply system can thus be responded to while variation in output voltage VP is suppressed.

According to this embodiment, inverter 23 (three-phase inverter) included in PCU 20 of electrically powered vehicle V is diverted for use as converter 2 of power supply sub unit Su. Battery pack 1 of electrically powered vehicle V is used as battery pack 1 of power supply sub unit Su. Therefore, reuse of a battery or a PCU collected on the occasion of replacement purchase or disassembly of electrically powered vehicle V can be promoted.

In the embodiment, control device 3 carries out voltage control and power control in units of power supply sub unit Su, and three cell units Bu included in power supply sub unit Su are controlled under identical control (voltage control or power control). Control device 3, however, may subject single cell unit Bu to voltage control and may successively switch cell unit Bu to be subjected to voltage control. Since cell unit Bu other than single cell unit Bu subjected to voltage control is thus subjected to power control, responsiveness in power control can be enhanced and the difference between output power OP and power command RP can be made smaller. Power variation in the load connected to power supply system P can thus be responded to while variation in output voltage VP is suppressed. Two cell units Bu or four cell units Bu may simultaneously be subjected to voltage control.

### First Modification

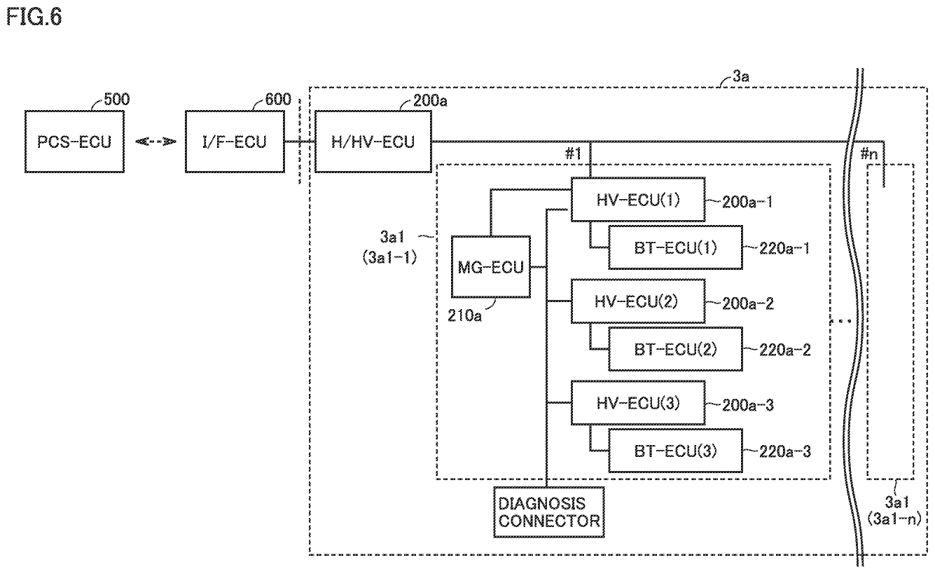

FIG. 6 is a diagram illustrating a control device 3a of power supply system P according to a first modification. Control device 3a in the first modification utilizes and makes use of HV-ECU 200, MG-ECU 210, and BT-ECU 220 mounted on electrically powered vehicle V. In FIG. 6, HV-ECU 200 mounted on electrically powered vehicle V is utilized and made use of as an H/HV-ECU 200a and an HV-ECU (1) 200a-1 to an HV-ECU (3) 200a-3. MG-ECU 210 is utilized and made use of as an MG-ECU 210a. BT-ECU 220 is utilized and made use of as a BT-ECU (1) 220a-1 to a BT-ECU (3) 220a-3.

In FIG. 6, an interface ECU (I/F-ECU) 600 connects PCS-ECU 500 and control device 3a (H/HV-ECU 200a) to each other and adjusts consistency between a communication protocol of PCS-ECU 500 and a communication protocol of control device 3a. H/HV-ECU 200a computes power command TP (N) or the like for each cell unit Bu based on power command RP, voltage command RV, or the like received from PCS-ECU 500.

A sub control device 3a1 composed of MG-ECU 210a, HV-ECU (1) 200a-1 to HV-ECU (3) 200a-3, and BT-ECU (1) 220a-1 to BT-ECU (3) 220a-3 is a control device that controls power supply sub unit Su, and performs a function as a sub unit control unit Suc in FIG. 4. In FIG. 6, a sub control device 3a1-1 is a control device that controls power supply sub unit Su-1 in FIG. 1 and performs a function as a sub unit control unit Suc-1 in FIG. 4. Sub control device 3a1 is provided for each power supply sub unit Su and control device 3a includes n sub control devices 3a1 from sub control device 3a1-1 to a sub control device 3a1-n.

In FIG. 6, BT-ECU (1) 220a-1 monitors voltage VB, input and output current IB, a temperature, and the like of battery 10 of battery pack 1-1-1 of power supply sub unit Su-1 and calculates the SOC. BT-ECU (1) 220a-1 computes states of health (SOH) representing a state of battery 10 of battery pack 1-1-1 in power supply sub unit Su-1 based on a history or the like of voltage VB, input and output current IB, and temperature TB. The SOH may be represented, for example, by a capacity retention or a rate of increase in internal resistance of battery 10 and it is a parameter representing a degree of deterioration of battery 10. HV-ECU (1) 200a-1 controls switching of SMR 11 of battery pack 1-1-1 based on power command TP (1-1-1) or voltage command RV. HV-ECU (1) 200a-1 detects a degree of deterioration of battery 10 of battery pack 1-1-1. A BT-ECU (2) 220a-2 and an HV-ECU (2) 200a-2 perform processing on a battery pack 1-1-2 similarly to BT-ECU (1) 220a-1 and HV-ECU (1) 200a-1. A BT-ECU (3) 220a-3 and an HV-ECU (3) 200a-3 perform processing on a battery pack 1-1-3 similarly to BT-ECU (1) 220a-1 and HV-ECU (1) 200a-1. MG-ECU 210a calculates duty ratio Du (1-1-1) as described above based on voltage command RV, power command TP (1-1-1), and the like, and controls converter 2 (drives the switching element in the U-phase arm of inverter 23).

A sub control device 3a1-2 to sub control device 3al-n also perform processing on a power supply sub unit Su-2 to power supply sub unit Su-n similarly to sub control device 3a1-1

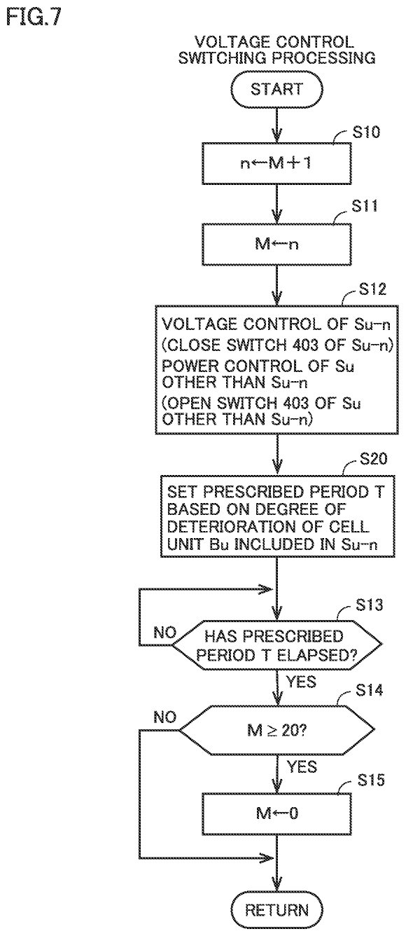

FIG. 7 is a flowchart showing exemplary voltage control switching processing performed by control device 3a in the first modification. The flowchart additionally includes S20 between S12 and S13 in the flowchart in FIG. 5.

In S20, prescribed period T is set based on the degree of deterioration of battery packs 1 (batteries 10) of three cell units Bu included in power supply sub unit Su-n. In the first modification, prescribed period T is set, for example, based on the lowest capacity retention among capacity retentions found by BT-ECU (1) 220a-1 to BT-ECU (3) 220a-3. Prescribed period T is set to be shorter as the capacity retention is lower (the degree of deterioration is higher). When the rate of increase in internal resistance is adopted as the degree of deterioration, prescribed period T is set based on the highest rate of increase in internal resistance among the rates of increase in internal resistance found by BT-ECU (1) 220a-1 to BT-ECU (3) 220a-3. Prescribed period T is set to be shorter as the rate of increase in internal resistance is higher (the degree of deterioration is higher).

In S13, prescribed period T set in S20 is used, and whether or not prescribed period T has elapsed since start of voltage control of power supply sub unit Su-n is determined.

According to this first modification, utilization and use of hardware of HV-ECU 200, MG-ECU 210, and BT-ECU 220 mounted on electrically powered vehicle V as the control device of power supply system P can be promoted. Such resources for controller area network (CAN) communication utilized in HV-ECU 200, MG-ECU 210, and BT-ECU 220 mounted on electrically powered vehicle V can also be made use of, and highly reliable multiplexed communication or monitoring can relatively easily be achieved.

In voltage control and power control in units of power supply sub unit Su composed of the three-phase inverter and three cells connected to the three-phase inverter, hardware of the ECU that carries out drive control of PCU 20 (three-phase inverter) can relatively easily be made use of as control device 3a. Utilization and use of the ECU that carries out drive control of PCU 20 (three-phase inverter) of the electrically powered vehicle as control device 3a can thus be promoted.

According to this first modification, prescribed period T is set in accordance with a state of cell unit Bu subjected to voltage control. As the degree of deterioration of battery pack 1 (battery 10) included in cell unit Bu is higher, prescribed period T is shorter. As the degree of deterioration of battery 10 is higher, a period for voltage control of cell unit Bu including that battery 10 is shorter and further deterioration of that cell unit Bu can be suppressed.

Prescribed period T may be set based on the SOC of battery pack 1 (battery 10). For example, as the SOC at the time of start of voltage control of battery pack 1 (battery 10) included in cell unit Bu subjected to voltage control is lower, shorter prescribed period T may be set.

In the first modification as well, control device 3a may subject single cell unit Bu to voltage control and may successively switch cell unit Bu to be subjected to voltage control. In control device 3 in the embodiment, the degree of deterioration of battery pack 1 (battery 10) included in cell unit Bu may be calculated, and prescribed period T may be shorter as the degree of deterioration is higher.

### Second Modification

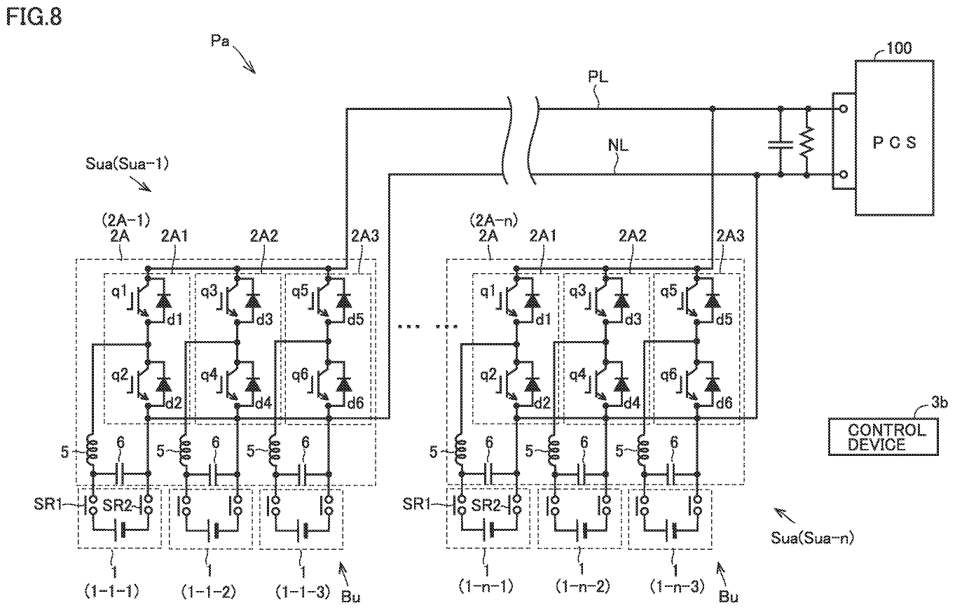

FIG. 8 is a diagram showing an overall configuration of a power supply system Pa in a second modification. In the embodiment, an example in which PCU 20 including boost converter 21, inverter 22, and inverter 23 is diverted for use as converter 2 of power supply system P is described. In the embodiment, in particular for conduction of high power, inverter 23 where switching elements are provided in parallel is utilized as the switching element of converter 2. Among PCUs mounted on electrically powered vehicles, however, there is a PCU where a single inverter is provided or a PCU without a boost converter.

In power supply system Pa in the second modification, a PCU including only a single inverter or a circuit resulting from extraction of an inverter portion from the PCU is diverted for use as a converter 2A thereof.

In FIG. 8, the inverter (three-phase inverter) of the PCU mounted on the electrically powered vehicle is diverted for use as converter 2A. In FIG. 8, SR1 and SR2 in battery pack 1 each represent a system main relay (SMR). As in the embodiment, the positive terminals of the output terminals of three battery packs 1 (1-1-1, 1-1-2, and 1-1-3) are connected to the intermediate points of the arms of phases (a U-phase arm 2A1, a V-phase arm 2A2, and a W-phase arm 2A3) of the three-phase inverter of the PCU with coils (inductors) 5 being interposed. The power line between the positive terminal of battery pack 1 and coil 5 is connected to the negative terminal of the output terminal of battery pack 1 with capacitor 6 being interposed. Upper arms of the arms (U-phase arm 2A1, V-phase arm 2A2, and W-phase arm 2A3) of the phases of the three-phase inverter are connected to positive electrode line PL and connected to the input and output terminal of PCS 100. Lower arms of the arms (U-phase arm 2A1, V-phase arm 2A2, and W-phase arm 2A3) of the phases of the three-phase inverter are connected to negative electrode line NL and connected to the input and output terminal of PCS 100. The negative terminal of battery pack 1 is connected to negative electrode line NL.

Thus, in power supply system Pa in the second modification, the arms of the phases of the three-phase inverter of the PCU are connected to battery pack 1 and the three-phase inverter is diverted for use as converter 2A, to thereby implement a power supply sub unit Sua including three cell units Bu. Power supply system Pa includes a plurality of power supply sub units Sua as in the embodiment and power supply sub units Sua are connected in parallel. A function and effect as in the embodiment is achieved also in this second modification by voltage control by a control device 3b as in the embodiment.

Though embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power supply system comprising:
a plurality of cell units each including a cell and a converter, the plurality of cell units being connected in parallel to each other; and
a control device that controls each of the plurality of cell units, wherein
the control device
subjects at least one cell unit of the plurality of cell units to voltage control such that an output voltage from the power supply system attains to a voltage command and subjects remaining cell unit(s) to power control such that output power from the power supply system attains to a power command, and
is configured to switch the at least one cell unit to be subjected to the voltage control every prescribed period.

2. The power supply system according to claim 1, wherein
a single cell unit is provided as the at least one cell unit.

3. The power supply system according to claim 1, wherein
a three-phase inverter is diverted for use as the converter, and
cells different from one another are connected to arms of respective phases of the three-phase inverter.

4. The power supply system according to claim 3, further comprising a plurality of power supply sub units connected in parallel to each other, each of the plurality of power supply sub units including three cell units, wherein
the three cell units include the cells connected to the arms of different phases of the three-phase inverter, respectively, and
the control device is configured to carry out the voltage control and the power control in units of a power supply sub unit of the plurality of power supply sub units.

5. The power supply system according to claim 4, wherein
a single power supply sub unit of the plurality of power supply sub units is subjected to the voltage control.

6. The power supply system according to claim 1, wherein
the control device sets the prescribed period in accordance with a state of the at least one cell unit subjected to the voltage control.

7. The power supply system according to claim 6, wherein
the state is represented by a degree of deterioration of the cell included in the at least one cell unit, and
the control device sets the prescribed period to be shorter as the degree of deterioration is higher.
